(19) United States
(12) Patent Application Publication
(10) Pub. No.: US 2017/0315712 A1
(43) Pub. Date: Nov. 2, 2017

(54) Feature Switching In A Multi-Tenant Cloud Service

(71) Applicant: International Business Machines Corporation, Armonk, NY (US)

(72) Inventors: John D. Curtis, Milford, MA (US); Terry J. Linsey, Littleton, MA (US); Shi M. Qu, beijing (CN); Meredith I. Roman, Lowell, MA (US); Meghan E. Russ, Belmont, MA (US); Azadeh Salehi, Pepperell, MA (US); William A. Spencer, Westford, MA (US); Ya N. Zhang, Beijing (CN)

(21) Appl. No.: 15/143,840

(22) Filed: May 2, 2016

(51) Int. Cl. G06F 3/0484; H04L 29/08

(52) U.S. Cl. CPC G06F 3/04847; H04L 67/18; G06F 3/04842; H04L 67/10

(57) ABSTRACT

Techniques are described for feature switching in a multi-tenant cloud service. In one implementation, a computer program product comprises a computer-readable storage medium having program code embodied therewith. The program code is executable by a computing device to provide a user interface to modify feature controls of a multi-tenant cloud service, identify a set of users whose support changes according to the feature controls, and adjust the feature controls based on the identified set of users.

### TECHNICAL FIELD

The invention relates to systems and software for cloud computing.

### BACKGROUND

The control over the variance of feature exposure, functionality and system configuration in multi-tenant software as a service offerings is dynamic, atomic and absolute. Means are well known that support selective “dark launch” for permitting (or forbidding) access to new features within a service. What remains unexploited is the full gamut of means to target a community, triggering mechanisms and granted control points for complete benefit in service offerings.

### SUMMARY

In general, examples disclosed herein are directed to techniques for feature switching in a cloud service. In one example, techniques include: providing a user interface to modify feature controls of a multi-tenant cloud service, identifying a set of users whose support changes according to the feature controls; and adjusting the feature controls based on the identified set of users.

In other example, a computer system includes one or more processors, one or more computer-readable memories, and one or more computer-readable, tangible storage devices. Program instructions are stored on at least one of the one or more storage devices for execution by at least one of the one or more processors via at least one of the one or more memories, to provide a user interface to modify feature controls of a multi-tenant cloud service, identify a set of users whose support changes according to the feature controls, and adjust the feature controls based on the identified set of users.

In another example, a computer program product includes a computer-readable storage medium has program code embodied therewith. The program code is executable by a computing device to provide a user interface to modify feature controls of a multi-tenant cloud service, identify a set of users whose support changes according to the feature controls, and adjust the feature controls based on the identified set of users.

### BRIEF DESCRIPTION OF DRAWINGS

FIG. 1A illustrates an example user interface for grouping features.

FIG. 1B illustrates an example user interface for defining user sets.

FIG. 1C illustrates an example user interface for editing privileges.

FIG. 1D illustrates an example user interface for selecting an enablement method.

FIG. 2 is a flow diagram of a method for feature switching in a cloud.

FIG. 3 is a block diagram of a computing device for feature switching in a cloud service.

### DETAILED DESCRIPTION

Various examples are disclosed herein for feature switching in a multi-tenant cloud service. In one aspect, the disclosed techniques allow for grouping of feature controls into sets of switchable functionality with user-friendly names, and creates a group of users to be targeted by the feature switch automatically. A service administrator uses a user interface to choose a (combination of) features or capabilities to be toggled and create method(s) of identifying a target community of qualified entities (users or groups). Additional user interfaces are provided for the administrator to create toggle rules. These settings are then used to enact the switch and take action concerning the targeted community. Existing social software may be used to provide the interaction among the generated membership of the social community. Membership in a target community can automatically promoted to or revoked from a named social community.

The definition of the target community to be target for the setting and the means or rules of triggering the setting may be offered in combinatorial variation. Techniques are disclosed for identifying a community of organizations and users that will be target by the feature switch or toggle. The means of community identification can be combined to construct a set of target users. The phrase “target community” is used in what follows. It is to be distinguished from a “social community” which denotes (a) group(s) of users grouped by means of social software. That is, “target community” is a manufactured group.

The target community can be constructed in a variety of ways, including but not limited to:

Straight sample (random, every N) or every N within subset—The target community is constructed automatically using sampling means. Random selection or one user or company of every N. This selection means can function within a subset (e.g. a fixed set of companies) as well.

Location (IP address, language, locale)—Using session/network data as demographics, a target community is chosen.

Corporate citizenship or demographics (not just a tenant but also community in the service)—Using company residence or social media community membership, a target community is defined. Vendor-chosen customers and users who have purchased the most or the least services. Also, corporate structure ranking (e.g. C level executives).

First N, last N., middle N (sample sessions across time)—Gathering sessions across some fixed period of time, a target community is chosen using first, last or middle sets of session users.

Frequency, how recent the use or access (or lack thereof)—A record of access and/or use (of the service or of specific objects or operations/processing) is maintained, and the target community is chosen depending upon how frequently, recently, regularity or other patterns of use or access.

Usage patterns—# of transactions/session—A target community is chosen by raw load on the service—both high usage and low. This method counts transactions and/or sessions.

Size of data (in service, transferred/session)—small or large—Independent of the load of sessions, this identifies the target community by a measure of data transferred, both high and low.

Combining the rules of how a target community is defined is an important part of the invention. Generally, intersecting (or ANDing) the selection rules (e.g. a. & b. & e.), will serve to limit the community and zero in on the demographics and may even result in an unworkably small target community. These techniques include a full boolean expression means for building the target community also (e.g. (a. & b. & e)|(f. & g.)), though this clouds most evaluation techniques aimed at assessing the effects of the feature switching. As described above, the target community can also be used to generate a social business community for interaction in a forum context concerning experiences and to gain valuable feedback. And, except in the a., d. and e. cases, if a user's usage patterns cease to match the criteria, that user will be moved from the social community.

### Toggle Rules

Instead of depending upon UI/manual means of effecting the feature switch (though UI means are used to specify the rules below), the invention utilizes automated means, including but not limited to:

Schedule—hard or periodic—The feature switch is toggled based upon specific points in time. This can be time of day (GMT) or periodic (switch for 2 hours, switch back for 4, repeat for X total hours).

Triggered—The feature switch is enabled and disabled by the detection of specific phenomena in the service, including but not limited to:
Event (dynamic)—An automatically identifiable specific user or system software update or transaction, system resource usage or performance phenomenon (CPU, disk, memory) or execution characteristics of system utilities or maintenance procedures.
State (static)—An identifiable, persistent state of system resources, fixed or average size of specific objects or object types, thresholds or combinations of thresholds exceeded including sessions, users or other load phenomena. Note that this type of toggle rule (or method of enablement, below) can be seen as complimentary to target Community rules e., f. and g. above. It is discrete from those community types, though complimentary in its execution (that is, other community types can be triggered as well).

Progressive settings (add setting on top of setting . . . when . . . )—Feature switching can be cumulative. Using some set of criteria above, prescribe a progressive switching of features.

Surrender to persistence (soft toggle that yields to pressure)—When the means to use switched-off feature or the means to turn off a switched-on feature is presented, yield to user or software persistence. The value of this capability may sound questionable, but it can be used to gather usability data. The exposure to hacking is minimized by means of robust authentication. The toggle means can also be combined. Scheduled and triggered presents a more restrictive toggling than each method taken by itself.

Business Aims

The above-described techniques add value in each of the following vendor-based actions:

Dark launch—This is the classic capability of making features available to a target community but no one else. Given the automatic execution in the invention, dark launch has radical new dimensions and results.

Dark deprecation—To test the turning off of features or making software or hardware resources unavailable or cheaper in any way, sampling an target community to measure complaints or processing effect on other system and service resources is extremely desirable.

Paid selective service subscription—Features can be specially priced. Customers can buy usage by N concurrent users, and the target community can be dynamically adjusted according to specification.

Unpaid service denial—When subscriptions go unpaid, the service can start selectively failing as a warning before totally disabling a target community.

Marketing pilots—To check for interest, gather reactions and study usability patterns, a target community can serve as an aid to marketing. Surveys can be gathered at the end of a trial or automatically generated by studying behavior.

Customer pilots/research—As a paid feature, giving customers privileges to control feature switching using all means of defining their own target community and toggle rules allows for customers to “test the waters” and gather interest level and realized value for features before they purchase subscriptions.

Community benefits and privileges—As members of a social community, users obtain access to features pertaining to that communities interest(s). To enact this functionality, there are two classes of components—the UI specification component and the Feature switch itself.

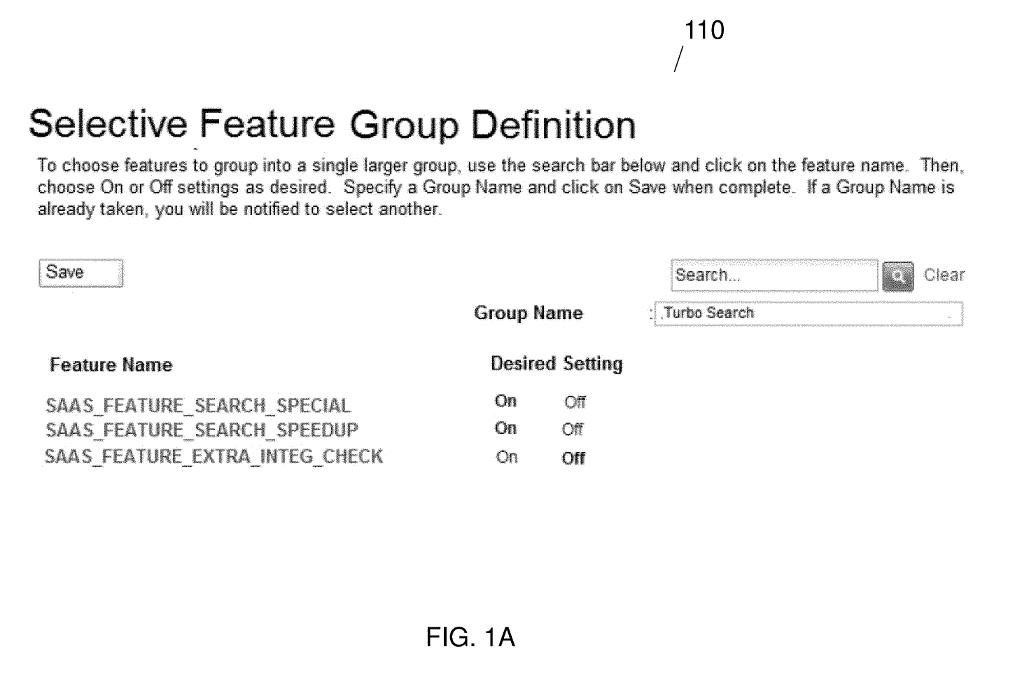

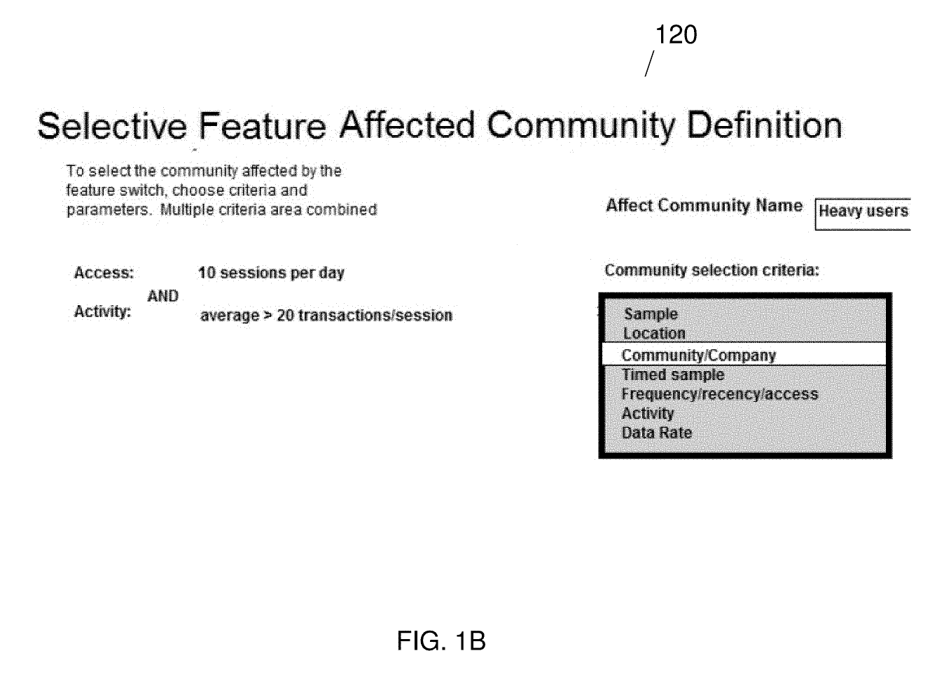

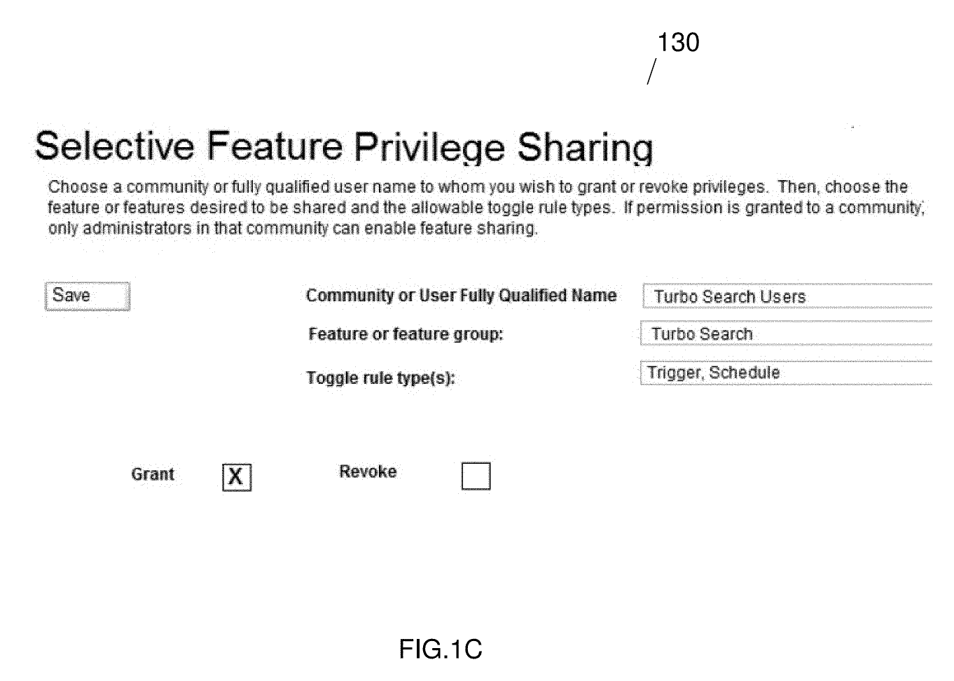

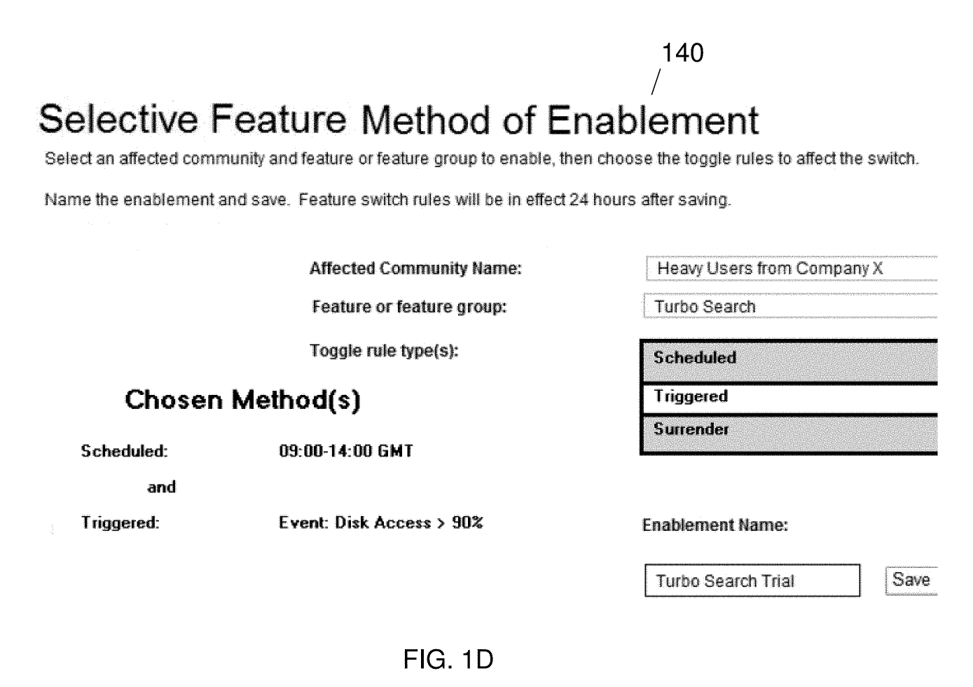

FIGS. 1A-1D illustrates example user interfaces for executing the above-described techniques. As shown in FIG. 1A, a user interface 110 is provided that allows for the grouping of multiple feature values into a new named feature group. Work to group features like this can be done independently of any specification of their enactment.

As shown in FIG. 1B, a user interface 120 is provided that allows for the target community to be specified once feature groups are defined. This is done by choosing criteria and specifying the detail for each.

As shown in FIG. 1C, a user interface 130 is provided that allows for granting or revoking privileges to perform feature switching. This is done by choosing a user or community for which privileges are to be granted or revoked, and choosing the features to be shared and allowable toggle rule types.

As shown in FIG. 1D, a user interface 140 is provided for choosing an enablement method, and naming and enacting the chosen enablement method.

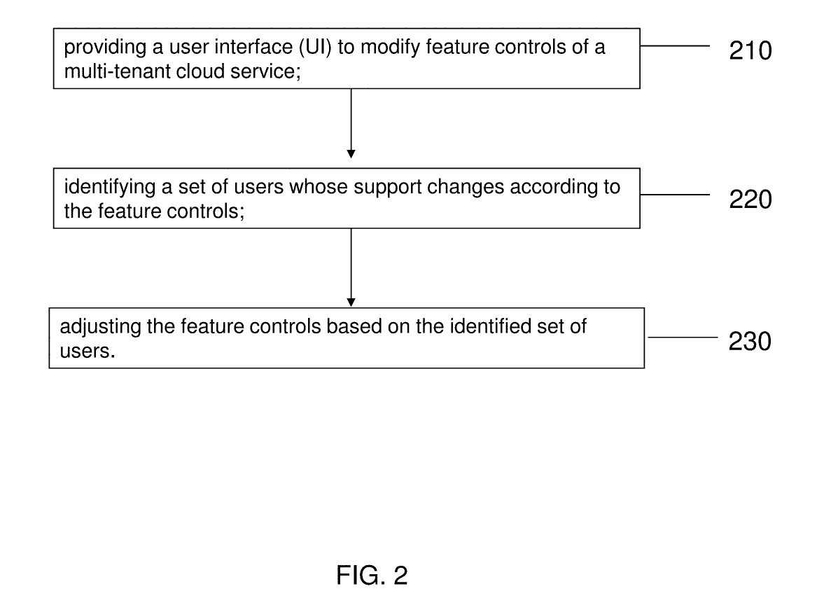

As shown in FIG. 2, a method for feature switching in a cloud service includes providing a user interface to modify feature controls of a multi-tenant cloud service (210); identifying a set of users whose support changes according to the feature controls (220); and adjusting the feature controls based on the identified set of users (230).

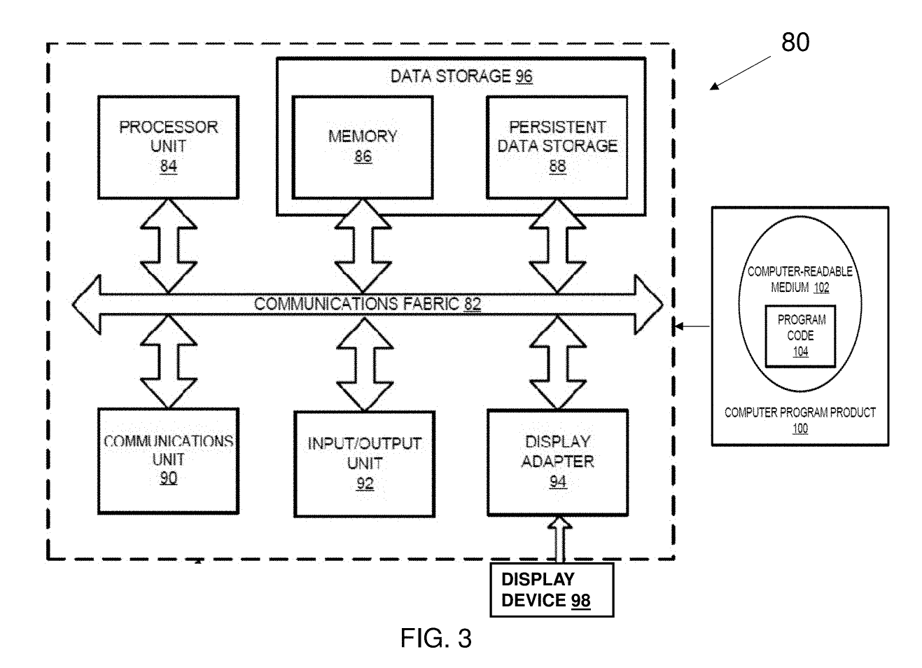

In the illustrative example of FIG. 3, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an ×86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Some examples may use such a non-transitory medium. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a semantic model constructor 22, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention.

It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for switching features of a multi-tenant cloud service comprising:
providing a user interface to modify feature controls of a multi-tenant cloud service;
identifying a set of users whose support changes according to the feature controls; and
adjusting the feature controls based on the identified set of users.

2. The method of claim 1, wherein identifying a set of users includes:
constructing a set of users using sampling.

3. The method of claim 1, wherein identifying a set of users includes:
constructing a set of users using location information for the users.

4. The method of claim 1, wherein identifying a set of users includes:
constructing a set of users using membership information for the users.

5. The method of claim 1, wherein identifying a set of users includes:
constructing a set of users using access pattern information for the users.

6. The method of claim 1, further comprising:
selecting a plurality of feature controls to group into a single larger group.

7. The method of claim 1, wherein providing a user interface to modify feature controls of a multi-tenant cloud service includes:
providing a user interface to grant or revoke sharing privileges for the feature controls.

8. The method of claim 1, wherein providing a user interface to modify feature controls of a multi-tenant cloud service includes:
providing a user interface to select an enablement method for feature switching.

9. The method of claim 1, wherein identifying a set of users further comprises:
Using the identified set of users to generate a social business community for interaction in an electronic forum.

10. A computer system comprising:
one or more processors, one or more computer-readable memories, and one or more computer-readable, tangible storage devices; and
program instructions, stored on at least one of the one or more storage devices for execution by at least one of the one or more processors via at least one of the one or more memories to perform operations comprising:
providing a user interface to modify feature controls of a multi-tenant cloud service;
identifying a set of users whose support changes according to the feature controls; and
adjusting the feature controls based on the identified set of users.

11. The system of claim 10, wherein identifying a set of users includes:
constructing a set of users using membership information for the users.

12. The system of claim 10, wherein identifying a set of users includes:
constructing a set of users using access pattern information for the users.

13. The system of claim 10, wherein the operations further comprise:
selecting a plurality of feature controls to group into a single larger group.

14. The system of claim 10, wherein identifying a set of users further comprises:
Using the identified set of users to generate a social business community for interaction in an electronic forum.

15. A computer program product comprising a computer-readable storage medium having program code embodied therewith, the program code executable by a computing device to perform operations comprising:
providing a user interface to modify feature controls of a multi-tenant cloud service;
identifying a set of users whose support changes according to the feature controls; and
adjusting the feature controls based on the identified set of users.

16. The program product of claim 15, wherein identifying a set of users includes:
constructing a set of users using membership information for the users.

17. The program product of claim 15, wherein identifying a set of users includes:
constructing a set of users using access pattern information for the users.

18. The program product of claim 15, wherein the operations further comprise:
selecting a plurality of feature controls to group into a single larger group.

19. The program product of claim 15, wherein identifying a set of users further comprises:
using the identified set of users to generate a social business community for interaction in an electronic forum.

20. The program product of claim 15, wherein providing a user interface to modify feature controls of a multi-tenant cloud service includes:
providing a user interface to grant or revoke sharing privileges for the feature controls.
